(19) United States
(12) Patent Application Publication
(10) Pub. No.: US 2020/0389352 A1
(43) Pub. Date: Dec. 10, 2020

(54) AUTOMATED UPGRADE OF MULTIPLE HOSTS

(71) Applicant: Microsoft Technology Licensing, LLC, Redmond, WA (US)

(72) Inventor: Hengyang Hu, Burlingame, CA (US)

(21) Appl. No.: 16/431,110

(22) Filed: Jun. 4, 2019

(51) Int. Cl. H04L 12/24; H04L 29/08

(52) U.S. Cl. CPC H04L 41/082; H04L 67/32; H04L 41/5012; H04L 41/5096

(57) ABSTRACT

Disclosed embodiments provide techniques for automated upgrading of multiple application hosts, wherein the techniques scale with the number of hosts. After the hosts and target applications that are to be upgraded are identified, for each application a corresponding maximum number of instances of the application that may be offline during the upgrade is identified. This number may be based on an offline tolerance of the application, which may specify a percentage of instances of the target applications, and/or other factors. In turn, each host becomes an upgrade candidate. The upgrade of the candidate host may proceed when, for each application deployed on the host, all currently executing instances of the application can be shut down or taken offline without the number of offline instances of the application among all hosts exceeding the corresponding maximum.

### BACKGROUND

This disclosure relates to the field of computer systems. More particularly, the disclosed embodiments relate to automated upgrading or updating of multiple computer systems that host applications.

Upgrading an organization's computing platforms, whether to install a new version of an operating system, apply a software patch, or for some other reason, becomes more complicated and requires more time as the organization's operations grow (e.g., as the number of hosts grows). A traditional technique of manually selecting a set of hosts, taking them offline, upgrading them, and putting them back into service does not scale well when the organization maintains hundreds or thousands of hosts.

Therefore, techniques are needed to reduce the time and effort required to upgrade multiple computing platforms.

### BRIEF DESCRIPTION OF THE FIGURES

FIG. 1 is a block diagram of a computing environment in which multiple host computing platforms are to be automatically upgraded, in accordance with some embodiments.

FIG. 2 is a flow chart illustrating a method of automated upgrading of multiple hosts, in accordance with some embodiments.

FIG. 3 is a flow chart illustrating a method of selecting one of multiple hosts for upgrade, in accordance with some embodiments.

FIG. 4 depicts a computer system or apparatus for controlling the automated upgrading of multiple hosts, in accordance with some embodiments.

In the figures, like reference numerals refer to the same figure elements.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

### Overview

The disclosed embodiments provide a method, apparatus, and system for upgrading or updating multiple computer platforms or hosts, wherein each platform or host executes one or more applications. These embodiments ensure that a given host is taken offline (or the target applications to be upgraded are taken offline) when a sufficient pool of other instances of the host's applications (e.g., instances that operate on other hosts) are online to handle the application's workload. Upgrading or updating an individual host (e.g., a blade server, a rack server) may involve installing new software, upgrading or replacing existing software, removing software, applying a patch, and/or other activity.

To ensure that a host is not taken offline at an inopportune time, statuses of each application are maintained that identify a total number of application instances running among all hosts (e.g., all hosts to be upgraded), a maximum number or percentage of all instances that may be offline at a time among the hosts to be upgraded, a number of instances currently offline (or online), a number of instances that may be taken offline in addition to any that are already offline, etc. A central process or supervisor for managing the upgrade procedure maintains and updates this information.

When a procedure to upgrade the hosts commences, the central process may rank them by one or more factors or criteria (e.g., number of applications deployed on each host, amount of traffic or rate of transactions handled by each host's applications) to determine a preferred order in which to upgrade them. When the current statuses of a given host's applications permit (e.g., when a sufficient number of other instances of the applications are online), it may be selected for upgrade. The applications' statuses are then updated to indicate that the host is no longer online (i.e., the target applications that are deployed on the host have been terminated or are being shut down), and it (or the applications) may then be taken offline and upgraded.

When a host's upgrade is complete, it is brought back online (e.g., each offline target application is restarted), the statuses of its deployed applications are updated to reflect their availability, and one or more other hosts may then be selected for upgrading. Multiple hosts, however, may be simultaneously upgraded if the statuses of the target applications permit.

By automating most or all of the process of upgrading multiple application hosts' deployed applications, the disclosed embodiments enable the upgrade process to scale with the number of hosts to be upgraded. Thus, thousands of hosts may be updated in a significantly shorter period of time than are required to update fewer hosts following traditional techniques.

In contrast, traditional techniques for upgrading an organization's computing platforms involves manual execution of scripts limited to individual tasks. Typically, engineers or operators would manually select a set of hosts, take them offline, update them, reboot them, select the next set of hosts, and so on. Moreover, some conventional techniques require a pool of offline spare hosts so that a target host can be replicated on an offline spare that is then brought online to handle the target host's workload while the target host is upgraded. The embodiments described herein do not require additional equipment, which provides a large savings in terms of computer resources that must be obtained, maintained, and only occasionally utilized.

### Automated Upgrade of Multiple Hosts

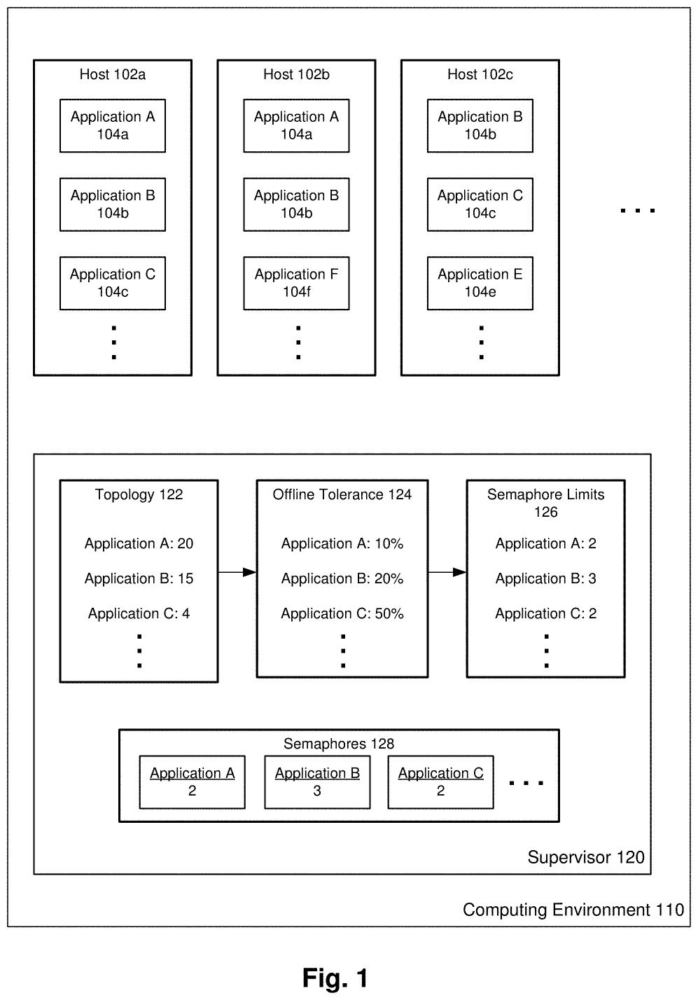

FIG. 1 is a block diagram of a computing environment in which multiple host computing platforms are to be automatically upgraded, according to some embodiments. As shown in FIG. 1, computing environment 110 includes multiple computing platforms or hosts that may be of varying (or similar) types, configurations, capacities, etc. Computing environment 110 may include part or all of a data center, may span multiple data centers, or may encompass some other collection of hosts that are or are not geographically proximate to each other. The hosts may or may not be operated by or for a single organization. In different embodiments the number of hosts may be in the hundreds, thousands, tens of thousands, etc.

Each host 102 (e.g., hosts 102a, 102b, 102c) executes one or more instances of each of one or more target applications 104 to be upgraded (e.g., application A 104a, application B 104b, application C 104c, application E 104e, application F 104f), and different hosts may execute different combinations of applications. Therefore, any number of instances of any given application may be executed by any given host.

Hosts 102 are coupled to clients and/or other application consumers (e.g., users of the applications/services executed by the hosts) and to supervisor 120 by one or more networks, including the Internet, an intranet, and/or other links. Although not shown in FIG. 1, one or more load balancers, front-end servers, and/or other entities may be logically situated between the application consumers and hosts 102.

Supervisor 120 is a computing platform for managing a procedure for upgrading or updating applications 104 and/or other components of hosts 102. Supervisor 120 includes or is coupled to a data store that stores data including topology 122, offline tolerance 124, semaphore limits 126, and semaphores 128. Supervisor 120 may also store (or have access to) other useful data, such as identities (e.g., names, network addresses) of the hosts to be upgraded, profiles of the hosts (e.g., which applications are deployed on each host, how many instances of each application each host executes), times/dates during which hosts/applications may (or may not) be taken offline and upgraded, and criteria or factors for ranking or ordering hosts for upgrading.

Topology data 122 (which may be termed an application topology) identifies the number of instances of each application that are executing among all hosts to be upgraded (e.g., hosts 102). Thus, as shown in FIG. 1, topology 122 indicates that hosts 102 execute 20 instances of application A 104a, 15 instances of application B 104b, and 4 instances of application C 104c.

Offline tolerance 124 identifies, for each application, a maximum percentage of the application's instances (i.e., the instances recorded in topology 122) that may be offline among hosts 102 at the same time during an upgrade procedure. In the embodiments reflected in FIG. 1, 10% of the instances of application A 104a, 20% of the instances of application B 104b, and 50% of the instances of application C 104c may be offline at any given time during the upgrade.

Semaphore limits 126 are derived from topology 122 and offline tolerance 124, and identify the maximum number of instances of each application that can be offline at a time during an upgrade procedure. Thus, 10% of 20 instances of application A 104a yields a semaphore limit of 2, 20% of 15 instances of application B 104b yields a semaphore limit of 3, and 50% of 4 instances of application C 104c yields a semaphore limit of 2. In some embodiments, supervisor 120 (or some other entity) periodically or regularly examines topology 122 and offline tolerance 124 for changes and, if any changes are detected, updates or recalculates semaphore limits 126 accordingly. In the illustrated embodiments, each semaphore limit 126 is a non-negative integer.

In the embodiments reflected in FIG. 1, each application's offline tolerance 124 is expressed as a percentage, which is used to calculate semaphore limits 126. In other embodiments, offline tolerance 124 and semaphore limits 126 may be conflated to simply identify (from topology 122) a maximum number of instances of each application that may be offline simultaneously during an upgrade procedure, without applying an intervening percentage. In other words, semaphore limits 126 may be set or calculated from topology 122 without applying explicit percentages such as those embodied in offline tolerance 124.

In some embodiments, topology 122 and/or offline tolerance 124 may be set by system engineers or operators, based on the computing environment, their knowledge of which hosts do and do not need to be upgraded, values used during previous upgrades, etc. In other embodiments these data may be determined automatically (e.g., by supervisor 120). For example, some or all hosts in computing environment 110, and/or other entities (e.g., other supervisors or monitors), may be polled to identify the total number of application instances (i.e., topology 122), and historical data may be consulted to determine a number or percentage of instances of each application that should remain online to satisfactorily handle an expected workload (e.g., with a desired quality of service). Semaphore limits 126 can then be calculated for each application by subtracting the number of instances to remain online from the total instances.

Semaphores 128 are dynamic values or counters that are regularly or continually updated during a host upgrade process. In particular, when a host is taken offline (when the applications to be executed on the host are shut down or terminated), for each application the corresponding semaphore is decremented by the number of instances of the application that the host had executed. As indicated below, the host normally will not be taken offline if the number of application instances it is currently executing is greater than the application's current semaphore. When a host is put back online (when its applications are restarted), the hosted applications' semaphores are increased appropriately. Updates to semaphores 128 are atomic in nature, and in embodiments described below a given semaphore will not be incremented beyond its corresponding semaphore limit.

During an upgrade procedure, topology 122, offline tolerance 124, semaphore limits 126, and semaphores 128 are dynamic in nature. If an application's semaphore limit 126 is increased during an upgrade procedure (e.g., because either topology 122 or offline tolerance 124 for the application were modified), the same increase will be applied to the application's semaphore 128.

Conversely, if an application's semaphore limit 126 is decreased during an upgrade procedure, the impact upon the application's current semaphore 128 depends on the magnitude of the decrease. If the current semaphore is less than or equal to the modified semaphore limit, the value of the semaphore is not changed. If the current semaphore is greater than the modified semaphore limit, the semaphore is decreased to the modified semaphore limit.

As a special case, however, if an upgrade procedure is to be aborted or cancelled after it starts, offline tolerances 124 and semaphore limits 126 are set to zero to cause the procedure to stop in a controlled manner. This will cause supervisor 120 to immediately set all semaphores 128 to zero and prevent them from being incremented. In this event, hosts that are offline may continue to be upgraded and brought back online if desired, but no more hosts will be taken offline because their semaphores do not permit any more application instances to be terminated.

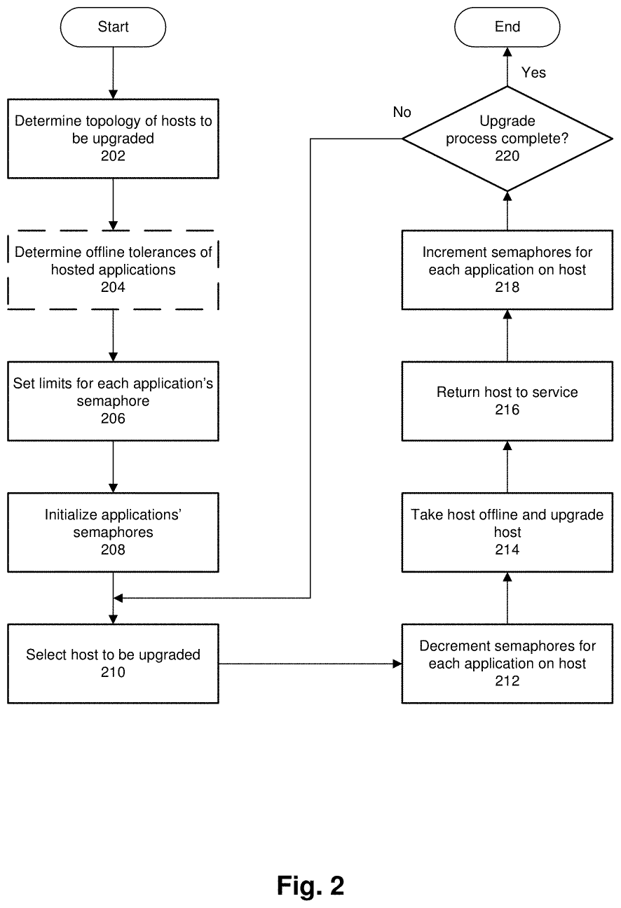

FIG. 2 is a flow chart illustrating a method of automated upgrading of multiple hosts according to some embodiments. In one or more embodiments, one or more of the steps may be omitted, repeated, and/or performed in a different order. Accordingly, the specific arrangement of steps shown in FIG. 2 should not be construed as limiting the scope of the embodiments.

In operation 202, the application topology of multiple hosts to be upgraded is obtained or determined. In particular, among the hosts within a target computing environment (e.g., some or all hosts supporting particular applications within an organization, all hosts within a data center), the applications and/or other software that are deployed on the hosts and that are to be upgraded are identified. Further, for each host, the number of currently executing instances of each application deployed on the host may be determined (e.g., the host's application profile) if not already known.

In optional operation 204, offline tolerances of the software examined in operation 202 may be obtained or determined. These tolerances may include percentages of each application's instances that may be offline at the same time during the current upgrade procedure. The tolerances may be permanently or semi-permanently associated with the applications or may be set based on the topology, the hosts' profiles, the relative importance of each application, the pace at which the upgrade should proceed (e.g., higher tolerances may allow more hosts to be offline at a time, thereby hastening the upgrade procedure), and/or other factors.

An application's offline tolerance may be alternatively expressed as a specific quantity of instances that may be offline simultaneously during the upgrade procedure, in which case this operation may be merged or combined with operation 206.

In operation 206, limits for semaphores associated with each target application are set. As discussed previously, each application's semaphore indicates, at any given time during the upgrade procedure, how many additional instances of the application may be taken offline, and is normally a value greater than or equal to 0. An application's semaphore limit is the maximum value the application's semaphore may obtain during the upgrade (when no instances of the application are offline).

If offline tolerances expressed as percentages are available, an application's semaphore limit is calculated based on its corresponding offline tolerance percentage and the total number of instances of the application (as reflected in the application topology). If offline tolerances are expressed as numbers instead of percentages, the semaphore limits may be set by copying the tolerances.

In operation 208, when the upgrade is about to start, and before any host or any host's applications are taken offline, each application's semaphore is set to its corresponding limit. Illustratively, if an application's semaphore limit (and therefore its initial semaphore value) is zero, that application cannot be terminated, taken offline, or upgraded on any host. If all applications' semaphore limits are zero, the upgrade procedure effectively ends.

The supervisor process or machine that is to oversee the upgrade procedure may store the application topology, offline tolerances, semaphore limits and/or other data (e.g., host profiles) in a local data store or these data may be stored elsewhere. The individual semaphore values are specifically maintained by the supervisor during the upgrade.

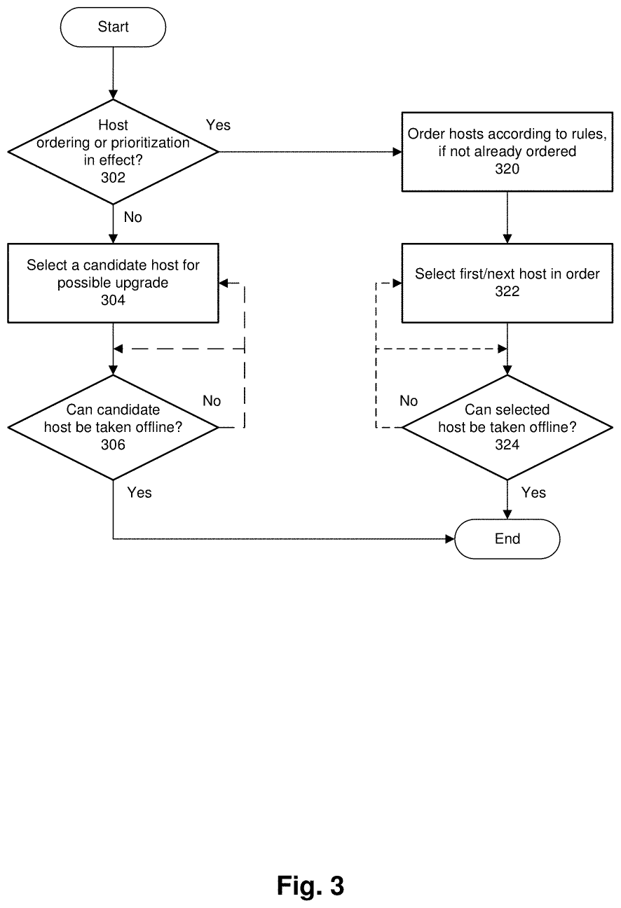

In operation 210, a host is selected to be upgraded. In some embodiments, a process illustrated in FIG. 3 and discussed below may be applied to select a host. For example, the hosts to be upgraded may be ranked or ordered in some manner and the supervisor will attempt to upgrade them in the specified order. Alternatively, hosts may be selected randomly, based on their locations (e.g., geographical locations, network addresses), their names, types (e.g., type or model of computer server), hardware configuration, etc.

It should be noted that a host will not normally be selected for upgrade unless and until the number of instances of each application that it hosts that has a corresponding semaphore is currently less than or equal to its corresponding semaphore value. However, in some alternative embodiments, upgrades of one or more hosts may be divided into multiple parts, and one or more different applications may be upgraded in each part.

In operation 212, for each target application on the selected host that has a corresponding semaphore, that semaphore is decremented by the number of instances of the application that are or were executing on the selected host. As indicated above, if the number of instances of an application deployed on the host is greater than the application's current semaphore at a given time, the host would not normally be selected to be upgraded at that time.

In operation 214, the selected host is taken offline and upgraded. The upgrade to the host may include updating, replacing, reconfiguring, removing, or installing new software and/or patches. In some embodiments, taking a host offline simply means that one or more applications deployed on the host are taken offline. This may involve prohibiting new connections to the host's application instances and either waiting for existing connections to complete or failing the existing connections over to another host. In some other embodiments, the entire host is taken offline for the upgrade.

In operation 216, the host is returned to service and placed online (e.g., by restarting the offline applications). It may be noted that the number of instances of any given application the host executes when brought back online may be equal to, greater than, or less than the number of instances it hosted before it was taken offline. For example, one or more applications may be removed from the host and/or one or more other applications may be newly deployed on the host.

In operation 218, for each application executing on the host post-upgrade that has a corresponding semaphore, the corresponding semaphore is incremented. For each such application that has the same number of instances on the host post-upgrade as pre-upgrade, the semaphore is incremented by that number of instances.

Other scenarios will cause the topologies of one or more applications to change to reflect more or fewer instances of the applications. These scenarios include deploying a new application on the host, removing an application from the host, and changing the number of instances of an application on the host. In these scenarios, the supervisor (or some other entity) will recalculate the applications' semaphore limits and, if a semaphore limit changes for a given application, its current semaphore value may also change.

In operation 220, the supervisor determines whether the upgrade procedure has completed. If all hosts/applications identified for upgrade have been upgraded, the procedure is complete and the method ends. If at least one host or one application has not yet been upgraded (the supervisor may maintain one or more counters for this purpose), the procedure is not yet complete and the method returns to operation 210.

FIG. 3 is a flow chart illustrating a method of selecting one of multiple hosts for upgrade according to some embodiments. In one or more embodiments, one or more of the steps may be omitted, repeated, and/or performed in a different order. Accordingly, the specific arrangement of steps shown in FIG. 3 should not be construed as limiting the scope of the embodiments.

In operation 302, a supervisor process or machine (or some other entity) determines whether a method of selecting a host to be upgraded, from among a set of all hosts to be upgraded, is based on a prioritization or ranking scheme. If such a scheme is active, the illustrated method advances to operation 320 and the supervisor will (or at least will attempt to) select the next host in order; otherwise, the method continues at operation 304.

In operation 304, a candidate host is selected for upgrading, either on a random basis or in some predictable order other than a prioritized ranking described further below. For example, the hosts may be upgraded according to their location, meaning that the supervisor may attempt to upgrade all hosts in one location (e.g., rack, cluster, data center) before tending to those in another location.

In operation 306, the supervisor determines whether the candidate host can be taken offline. In particular, the supervisor will compare (a) the number of instances of each application currently executing on the host and that are to be upgraded with (b) the applications' corresponding semaphore values. If each application's semaphore is greater than or equal to the number of instances of the application executing on the host, the candidate host can be taken offline and upgraded, and the illustrated method ends. Otherwise, the method returns to operation 304 to select a different candidate host or to wait a period of time to allow upgrades of one or more other hosts to complete, which may increase the applications' semaphores enough to permit the candidate host to be upgraded.

In operation 320, the hosts to be upgraded are ranked according one or more specified criteria or factors if they are not already ranked. In some embodiments, all hosts to be upgraded are ranked at the beginning of the upgrade procedure and the supervisor attempts to enforce that ranking. However, if a given host cannot be taken offline or upgraded for some reason, the ordering may be adjusted or a lower-ranked host may be upgraded before a higher-ranked host. In some other embodiments, hosts that have not yet been upgraded may be re-ranked periodically, such as every time a new host is to be selected, after some period of time passes, after some number or percentage of all hosts are upgraded, when the ranking criteria/factors change, when the application topology changes, etc.

A first illustrative ranking criterion or factor is the number of applications that are to be upgraded that execute on each host. By ranking hosts proportional to the number of target applications they execute, more applications (i.e., more application instances) will be updated sooner rather than later in the upgrade procedure.

A second illustrative ranking criterion or factor is the total traffic experienced by all target applications deployed on each host (e.g., queries per second, transactions per second), which may be an instantaneous measurement, a mean or median measured over some time period, or which may be measured in some other way. By prioritizing hosts that have greater workloads, more clients and/or other application consumers/users will experience the benefits of the upgrade sooner.

A third illustrative ranking criterion or factor is the total time required to upgrade the hosts/applications the last time an upgrade procedure was carried out (or an average or other aggregate measure of some number of upgrades). For this criterion, in the illustrated embodiments the time spent upgrading a given host encompasses the time needed to stop all applications to be upgraded (or to take the host offline), plus the time needed to upgrade the host/applications, plus the time necessary to put all applications back online. By ranking hosts inversely proportional to the amount of time estimated to be necessary to upgrade them, more hosts will be upgraded within a given period of time.

A fourth illustrative ranking criterion or factor relates to the applications. In particular, some or all applications are weighted or prioritized, and the host ranking process will attempt to upgrade hosts such that instances of a given high priority application will be upgraded before instances of a given lower priority application.

A fifth illustrative ranking criterion or factor is the allocation of host resources. For example, the higher percentage (or number) of a host's resources (e.g., processor cores, memory) that are allocated to the target applications, the higher the host is ranked. As a result, more computing resources will be able to take advantage of the upgrades sooner in the upgrade procedure.

In operation 322, the first or next host in order is selected (e.g., the highest ranked host that has not yet been upgraded).

In operation 324, the supervisor determines whether the host can be taken offline. In particular, the supervisor will compare the number of instances of each target application executing on the host with the applications' current semaphore values. If each application's semaphore is greater than or equal to the number of instances of the application executing on the host, the candidate host can be taken offline and upgraded, and the illustrated method ends. Otherwise, the supervisor may wait until the host can be taken offline or, in some embodiments, the method returns to operation 324 to select a different host (e.g., the next host in order).

Multiple hosts may often be upgraded simultaneously, depending on the hosts' profiles, the applications' semaphore limits and the applications' current semaphore values. Thus, after one host is selected and its upgrade process commences, one or more additional hosts may be selected and upgraded in parallel.

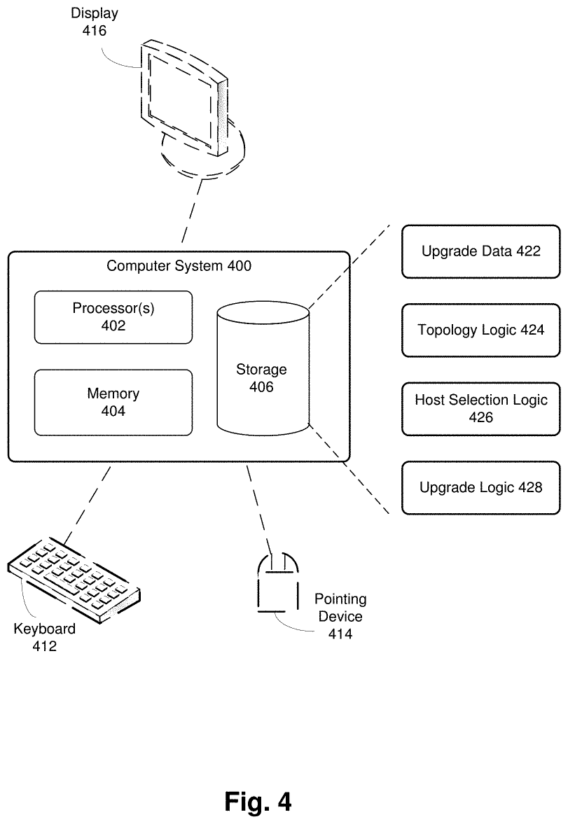

FIG. 4 depicts a computer system or apparatus for controlling the automated upgrading of multiple hosts, according to some embodiments. Computer system 400 of FIG. 4 includes processor(s) 402, memory 404, and storage 406, which may comprise any number of solid-state, magnetic, optical, and/or other types of storage components or devices. Storage 406 may include storage elements local to and/or remote from computer system 400. Computer system 400 can be coupled (permanently or temporarily) to keyboard 412, pointing device 414, and display 416.

Storage 406 stores upgrade data 422 used during a host upgrade procedure. Upgrade data 422 may include any or all of an application topology identifying total numbers of instances of target applications deployed on hosts to be upgraded, offline tolerances of the applications, a semaphore limit and a current semaphore value for each application, host profiles (a roster of each host's deployed applications and the number of instances of each application), an ordered list of the hosts, criteria/rules for ordering the hosts, and so on.

Storage 406 also stores logic and/or logic modules that may be loaded into memory 404 for execution by processor(s) 402, including optional topology logic 424, host selection logic 426, and upgrade logic 428. In other embodiments, some or all of these logic modules may be aggregated or further divided to combine or separate functionality as desired or as appropriate.

Topology logic 424 comprises processor-executable instructions for obtaining or determining an application topology for hosts to be upgraded and/or obtaining profiles of each host. For example, the topology logic may query individual hosts or other entities that can identify the target applications deployed on each host, the number of instances of each target application executing on the hosts, and the total number of instances of each application among the hosts to be upgraded.

Host selection logic 426 comprises processor-executable instructions for selecting individual hosts for upgrading. For example, the host selection logic may comprise instructions for selecting a host randomly, for ordering hosts according to some rule or criteria, and determining whether a candidate host can be upgraded (e.g., based on its profile and the semaphores of its deployed applications).

Upgrade logic 428 comprises processor-executable instructions for upgrading a host. After a host is selected for upgrading, the upgrade logic will ensure the applications to be upgraded are taken offline, perhaps gracefully by allowing existing connections to the application to complete or perhaps forcefully by severing existing connections. Upgrade logic 428 then applies application updates/patches and replaces/removes/installs software images as necessary. After the host is upgraded the target applications are restored to service.

One or more components of computer system 400 may be remotely located and connected to other components over a network. Portions of the present embodiments (e.g., different logic modules) may also be located on different nodes of a distributed system that implements the embodiments. For example, the present embodiments may be implemented using a cloud computing system that facilitates automated updating of host computers.

An environment in which one or more embodiments described above are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in the detailed description are typically stored on a computer-readable storage medium, which may be any device or medium that can store code and/or data for use by a computer system. The computer-readable storage medium may include, but is not limited to, volatile memory; non-volatile memory; magnetic and optical storage devices such as disk drives, magnetic tape, CDs (compact discs) and DVDs (digital versatile discs or digital video discs), solid-state drives, and/or other media now known or later developed that are capable of storing code and/or data.

Methods and processes described in the detailed description can be embodied as code and/or data, which may be stored in a computer-readable storage medium as described above. When a processor or computer system reads and executes the code and/or the data stored on the medium, the processor or computer system performs the methods and processes embodied as code and data structures and stored within the medium.

Furthermore, the methods and processes may be programmed into one or more hardware modules or apparatus such as, but not limited to, application-specific integrated circuit (ASIC) chips, field-programmable gate arrays (FPGAs), dedicated or shared processors (including a dedicated or shared processor core) that executes a particular software module or a piece of code at a particular time, and other programmable-logic devices now known or hereafter developed. When such a hardware module or apparatus is activated, it performs the methods and processed included within the module or apparatus.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A method, comprising:
identifying a plurality of host computers, wherein each host computer executes at least one instance of one or more of a set of target applications;
for each target application, identifying a corresponding maximum number of application instances that may be simultaneously offline among the host computers while the host computers are upgraded;
selecting a candidate host computer; and
upgrading the candidate host computer when, for each target application deployed on the candidate host computer, the corresponding maximum number of application instances is greater than a number of instances of the application currently offline among the host computers plus a number of instances of the application executing on the candidate host computer.

2. The method of claim 1, further comprising:
determining, for each target application, a total number of instances of the application executed on the host computers.

3. The method of claim 2, wherein identifying, for a given target application, the corresponding maximum number of application instances that may be simultaneously offline among the host computers while the host computers are upgraded comprises:
obtaining an offline tolerance of the application, wherein the offline tolerance comprises a percentage; and
calculating the maximum number of application instances that may be simultaneously offline based on the offline tolerance and the total number of instances of the application executed on the host computers.

4. The method of claim 1, further comprising, for each target application:
initializing a counter to the maximum number of application instances that may be simultaneously offline;
prior to upgrading the candidate host computer, decrementing the counter by the number of instances of the application executing on the candidate host computer; and
after the candidate host computer is upgraded, incrementing the counter.

5. The method of claim 1, wherein selecting the candidate host computer comprises:
ranking the host computers according to one or more factors; and
identifying the candidate host computer as the highest-rank host computer that has not yet been upgraded.

6. The method of claim 5, wherein the factors comprise, for each host computer, a quantity of target applications deployed on the host computer.

7. The method of claim 5, wherein the factors comprise, for each host computer, a total amount of communication traffic involving target applications deployed on the host computer.

8. The method of claim 5, wherein:
the factors comprise, for each host computer, an amount of time previously needed to upgrade the host computer; and
the amount of time previously needed to upgrade the host computer includes time needed to:
stop all instances of target applications executing on the host computer;
upgrade the target applications on the host computer; and
restart the target applications on the host computer.

9. The method of claim 5, wherein the factors comprise, for each host computer, identities of target applications deployed on the host computer.

10. The method of claim 5, wherein the factors comprise, for each host computer, a measure of one or more resources of the host computer allocated to target applications deployed on the host computer.

11. A system, comprising:
one or more processors; and
memory storing instructions that, when executed by the one or more processors, cause the system to:
identify a plurality of host computers, wherein each host computer executes at least one instance of one or more of a set of target applications;
for each target application, identify a corresponding maximum number of application instances that may be simultaneously offline among the host computers while the host computers are upgraded;
select a candidate host computer; and
upgrade the candidate host computer when, for each target application deployed on the candidate host computer, the corresponding maximum number of application instances is greater than a number of instances of the application currently offline among the host computers plus a number of instances of the application executing on the candidate host computer.

12. The system of claim 11, wherein identifying, for a given target application, the corresponding maximum number of application instances that may be simultaneously offline among the host computers while the host computers are upgraded comprises:
obtaining an offline tolerance of the application, wherein the offline tolerance comprises a percentage; and
calculating the maximum number of application instances that may be simultaneously offline based on the offline tolerance and a total number of instances of the application executed on the host computers.

13. The system of claim 11, wherein the memory further stores instructions that, when executed by the one or more processors, further cause the system to:
initialize a counter to the maximum number of application instances that may be simultaneously offline;
prior to upgrading the candidate host computer, decrement the counter by the number of instances of the application executing on the candidate host computer; and
after the candidate host computer is upgraded, increment the counter.

14. The system of claim 11, wherein selecting the candidate host computer comprises:
ranking the host computers according to one or more factors; and
identifying the candidate host computer as the highest-rank host computer that has not yet been upgraded.

15. The system of claim 14, wherein the factors comprise one or more of, for each host computer:
a quantity of target applications deployed on the host computer;
a total amount of communication traffic involving target applications deployed on the host computer;
identities of target applications deployed on the host computer; and
a measure of one or more resources of the host computer allocated to target applications deployed on the host computer.

16. The system of claim 14, wherein:
the factors comprise, for each host computer, an amount of time previously needed to upgrade the host computer; and
the amount of time previously needed to upgrade the host computer includes time needed to:
stop all instances of target applications executing on the host computer;
upgrade the target applications on the host computer; and
restart the target applications on the host computer.

17. A non-transitory computer-readable storage medium storing instructions that, when executed by a computer, cause the computer to perform a method, the method comprising:
identifying a plurality of host computers, wherein each host computer executes at least one instance of one or more of a set of target applications;
for each target application, identifying a corresponding maximum number of application instances that may be simultaneously offline among the host computers while the host computers are upgraded;
selecting a candidate host computer; and
upgrading the candidate host computer when, for each target application deployed on the candidate host computer, the corresponding maximum number of application instances is greater than a number of instances of the application currently offline among the host computers plus a number of instances of the application executing on the candidate host computer.

18. The non-transitory computer-readable storage medium of claim 17, wherein identifying, for a given target application, the corresponding maximum number of application instances that may be simultaneously offline among the host computers while the host computers are upgraded comprises:
obtaining an offline tolerance of the application, wherein the offline tolerance comprises a percentage; and
calculating the maximum number of application instances that may be simultaneously offline based on the offline tolerance and a total number of instances of the application executed on the host computers.

19. The non-transitory computer-readable storage medium of claim 17, wherein the method further comprises, for each target application:
initializing a counter to the maximum number of application instances that may be simultaneously offline;
prior to upgrading the candidate host computer, decrementing the counter by the number of instances of the application executing on the candidate host computer; and
after the candidate host computer is upgraded, incrementing the counter.

20. The non-transitory computer-readable storage medium of claim 17, wherein selecting the candidate host computer comprises:
ranking the host computers according to one or more factors; and
identifying the candidate host computer as the highest-rank host computer that has not yet been upgraded.
